(19) United States
(12) Patent Application Publication
(10) Pub. No.: US 2011/0145326 A1
(43) Pub. Date: Jun. 16, 2011

(54) WORKFLOW CUSTOMIZATION METHOD IN SaaS ENVIRONMENT

(75) Inventors: Won Jae Lee, Daejeon (KR); Hee Sun Won, Daejeon (KR); Sung Jin Hur, Daejeon (KR)

(73) Assignee: Electronics and Telecommunication Research Instutite, Daejeon (KR)

(21) Appl. No.: 12/785,678

(22) Filed: May 24, 2010

(30) Foreign Application Priority Data
Dec. 11, 2009 (KR) 10-2009-0123207

(51) Int. Cl. G06F 15/16; G06F 17/30

(52) U.S. Cl. 709/203; 707/769; 707/E17.014

(57) ABSTRACT

A method for providing a customized workflow service to offer a customized workflow software service in software as a service (SaaS) environment includes: providing currently set workflow information to a customized workflow software service client; and receiving a request for correction of workflow information from the client. Further, the method for providing the customized workflow service includes storing workflow information corrected in response to the request for correction of workflow information in a customized workflow database.

### CROSS-REFERENCE TO RELATED APPLICATIONS

The present invention claims priority of Korean Patent Application No. 10-2009-0123207, filed on Dec. 11, 2009, which is incorporated herein by reference.

### FIELD OF THE INVENTION

The present invention relates to a workflow customization method for a system that provides software services online, and more particularly, to a technique of providing a client-customized workflow software service in software as a service (SaaS) environment.

### BACKGROUND OF THE INVENTION

The purchase and maintenance of software, as well as the purchase and maintenance of hardware, are one of very important issues of all users and enterprises using computers. Especially, the enterprises have a burden on the purchase, maintenance and upgrade costs of various applications, such as OSs, office suites, and graphic programs, as much as on the purchase, maintenance and upgrade costs of hardware.

In addition, various finance, personnel and management programs, and programs of managing various kinds of data inside the enterprises need not only much purchase costs but also a separate expensive hardware.

However, with the advancement of network technology, there has been suggested a service which rents an application enabling the use of a variety of information solutions via the network infrastructure, without introducing expensive hardware and software. This service does not require the purchase and establishment of separate server and application, solves a burden of cost, time and people for management, and allows small and medium enterprises to easily acquire advanced management and work process. This enables the work innovation equivalent to the large enterprises, and thus becomes popular in recent years.

This service is further developed to have the concept of software as a service (SaaS), which is currently employed by many enterprises.

The SaaS has a distinct difference from the existing software in view of its circulation method. A general on-premises software or on-premises enterprise application software requires a process of describing and selling the products to the enterprise customers, and installing, upgrading and managing them. Thus, the customers have a significant burden on the possession of the products.

On the other hand, the SaaS allows its provider to offer services to clients via world wide web. The rental fee may be substituted by the advertisement profit or may be paid at a fixed monthly charge or in a meter-rate system. Thus, the customer has some advantages in costs and management, and both the software provider and customer enterprise are profitable.

However, the existing workflow software can define one workflow only for one enterprise. If the software service provider wants to provide several enterprises with the workflow software, several servers needs to have enterprise-customized workflows because each enterprise has a different workflow.

In other words, if a server is assigned to each enterprise to offer a workflow software service, the service provider that provides the software service must purchase and manage a large number of servers, OSs, and softwares. This makes the management cost and the cost of providing the service higher.

### SUMMARY OF THE INVENTION

In view of the above, the present invention provides a technique of enabling one server to provide multiple enterprises with a workflow software service, to thereby lower the management cost and provide an enterprise-customized workflow software service.

In accordance with a first aspect of the present invention, there is provided a method for providing a customized workflow service to offer a customized workflow software service in a software as a service (SaaS) environment, the method including: providing currently set workflow information to a customized workflow software service client; receiving a request for correction of workflow information from the client; and storing workflow information corrected in response to the request for correction of workflow information in a customized workflow database.

In accordance with a second aspect of the present invention, there is provided a method for providing a customized workflow software service in a software as a service (SaaS) environment, the method including: receiving a request for workflow execution from a client; checking a latest version of workflow information of the client; reading out the latest version of workflow information; and executing a workflow based on the read latest version of workflow information.

In accordance with a third aspect of the present invention, there is provided an apparatus for providing a customized workflow service to offer a customized workflow software service in a software as a service (SaaS) environment, the apparatus including: a customization editor for providing a customized workflow software service client with an interface for checking and editing workflow information; a basic workflow database for storing basic workflow information of the client; a customized workflow database for storing customized workflow information of the client; and a customization information version manager for managing workflow information corrected by the client using the customization editor, and storing the corrected workflow information in the customized workflow database.

In accordance with a fourth aspect of the present invention, there is provided an apparatus for providing a customized workflow software service in a software as a service (SaaS) environment, the apparatus including: a workflow executor for providing a customized workflow software service client with an interface for workflow execution, and executing a workflow requested by the client; a basic workflow database for storing basic workflow information of the client; a customized workflow database for storing customized workflow information of the client; and a customization information version manager for selectively reading out a latest version of workflow information from the basic workflow database or the customized workflow database in response to a request for workflow execution received through the workflow executor, and providing the latest version of workflow information to the workflow executor.

As described above, the present invention can provide a customized workflow service in a SaaS form, and thus efficiently offers multiple enterprises with a software service using a small number of servers.

In addition, one SaaS server executes several customized workflow softwares, thereby reducing the number of servers required for providing a software service. This decreases the purchase cost of servers, OSs and softwares, as well as the amount of power consumption and management cost. As a result, the workflow software service can be offered at a low price.

### BRIEF DESCRIPTION OF THE DRAWINGS

The objects and features of the present invention will become apparent from the following description of embodiments, given in conjunction with the accompanying drawings, in which:

FIG. 1 is a block diagram illustrating the schematic configuration of an apparatus for providing a customized workflow service to offer a customized workflow software service in a SaaS environment in accordance with an embodiment of the present invention;

FIG. 2 shows a flow chart describing a method for providing a customized workflow service to offer a customized workflow software service in a SaaS environment in accordance with the embodiment of the present invention;

FIG. 3 is a block diagram showing the schematic configuration of an apparatus for providing a customized workflow software service in a SaaS environment in accordance with an embodiment of the present invention; and

FIG. 4 is a flow chart describing a method for providing a customized workflow software service in a SaaS environment in accordance with the embodiment of the present invention.

### DETAILED DESCRIPTION OF THE EMBODIMENTS

Hereinafter, embodiments of the present invention will be described in detail with reference to the accompanying drawings which form a part hereof.

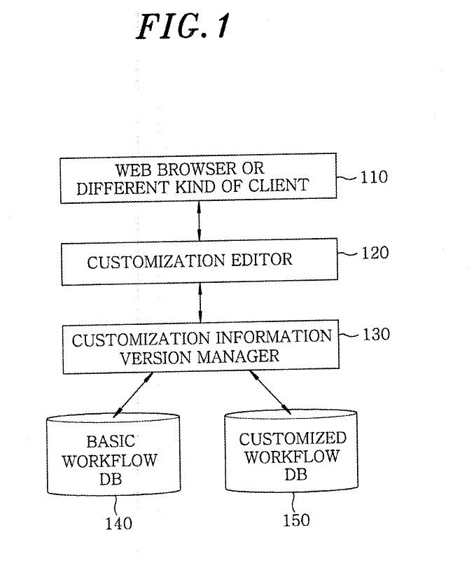

FIG. 1 is a block diagram illustrating the schematic configuration of an apparatus for providing a customized workflow service to offer a customized workflow software service in a software as a service (SaaS) environment in accordance with an embodiment of the present invention.

Referring to FIG. 1, the apparatus for providing a customized workflow service to offer a customized workflow software service in a SaaS environment in accordance with the embodiment of the present invention includes a customization editor 120 for providing a customized workflow software service client with an interface for checking and editing workflow information, a basic workflow database (DB) 140 for storing basic workflow information of a client, a customized workflow DB 150 for storing customized workflow information of the client, and a customization information version manager 130 for managing workflow information corrected by the client using the customization editor 120 and storing it in the customized workflow DB 150.

In the SaaS environment, the customized workflow software service client can connect to the apparatus for providing a customized workflow service in accordance with the present invention using his or her web browser or various connection applications. Upon connection, networks, such as an Internet network, a virtual private network (VPN) network, a wireless network, and so one, can be used. And, the client can use a terminal with diverse wired/wireless network functions, such as a personal desktop PC, a notebook PC, a portable phone, a portable multimedia player (PMP), or the like.

The client can perform workflow customization using an interface offered by the customization editor 120 through the web browser 110. The customization editor 120 provides the client with diverse functions of checking and editing workflow information. For example; it can provide the client with histories with corrected workflow information and version information corresponding to each of the corrected histories. In addition, the customization editor 120 can show to the client the workflow information stored in the form of XML process definition language (XPDL) in a business process modeling notation (BPMN) manner. Then, the client can see the workflow information offered by the customization editor 120 and correct the information suitably for the enterprise using it.

The customization information version manager 130 adds version information to the workflow information corrected by the client and then stores it in the customized workflow DB 150.

If the client firstly corrects basic workflow information stored in the basic workflow DB 140, the customization information version manager 130 stores new workflow information reflecting corrected contents in the customized workflow DB 150 which is provided for each client, rather than the basic workflow DB 140. The customization information version manager 130 also copies the basic workflow information into the customized workflow DB 150. Thereafter, when the workflow is corrected, a new version of workflow is stored in the customized workflow DB 150.

Now, a method for providing a customized workflow service in a SaaS environment executed by the apparatus for providing a customized workflow service to offer a customized workflow software service in a SaaS environment in accordance with the embodiment of the present invention having the configuration as above will be described.

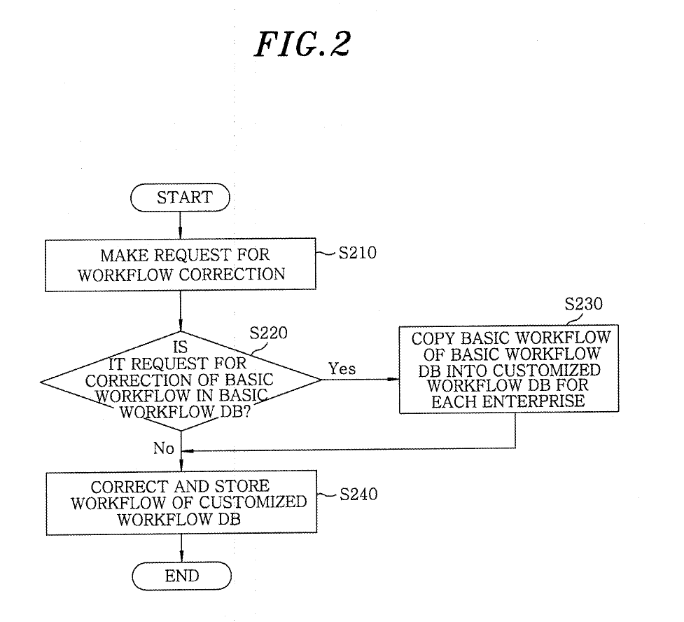

FIG. 2 is a flowchart describing a method for providing a customized workflow service to offer a customized workflow software service in a SaaS environment in accordance with the embodiment of the present invention.

Referring to FIG. 2, the client first tries to connect to the apparatus for providing a customized workflow service by his or her web browser 110. When the connection is made by the client, the customization editor 120 provides currently set workflow information to the client. The information provided may include histories with corrected workflow information and version information corresponding to each of the histories.

Then, the client makes a request for workflow correction using the customization editor 120 in step S210.

During the workflow correction operation that is done in response to the request for correction, if the currently set workflow information is basic workflow information stored in the basic workflow DB 140 and the client's correction request indicates a request for correction of the basic workflow information in step S220, the basic workflow information is copied into the customized workflow DB 150 in step S230. The corrected workflow information is also stored in the customized workflow DB 150 in step S240.

If the client's correction request does not indicate a request for correction of the basic workflow information, the corrected workflow information is stored directly in the customized workflow DB 150 in step S240.

At this time, version information corresponding to the corrected workflow information may be additionally stored.

The following is a description of an apparatus and method for providing a software service that realizes workflow customization using the customized workflow information which is set by the apparatus and method for providing a customized workflow service to offer a customized workflow software service in a SaaS environment in accordance with the embodiment of the present invention described above.

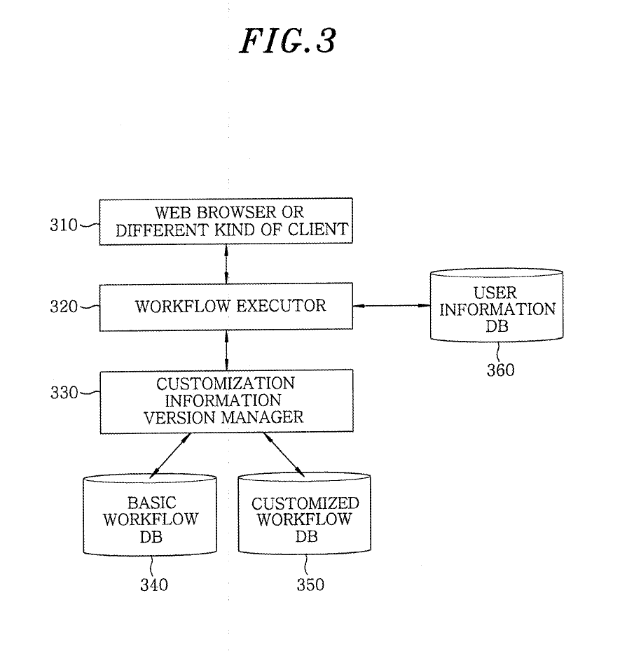

FIG. 3 is a block diagram illustrating the schematic configuration of an apparatus for providing a customized workflow software service in a SaaS environment in accordance with an embodiment of the present invention.

Referring to FIG. 3, the apparatus for providing a customized workflow software service in a SaaS environment in accordance with the embodiment of the present invention includes a workflow executor 320 for providing a customized workflow software service client with an interface for workflow execution and executing a workflow requested by a client, a basic workflow DB 340 for storing basic workflow information of the client, a customized workflow DB 350 for storing customized workflow information of the client, and a customization information version manager 330 for selectively reading out a latest version of workflow information from the basic workflow DB 340 or the customized workflow DB 350 in response to a request for workflow execution received by the workflow executor 320 and then providing it to the workflow executor 320.

First, the client makes a connection to the apparatus for providing a customized workflow software service in accordance with the present invention through a web browser 310, etc. Upon connection, networks such as an Internet network, a VPN network, a wireless network, and so on can be used, and the client can use a terminal with diverse wired/wireless network functions, such as a personal desktop PC, a notebook PC, a portable phone, a PMP, or the like.

The workflow executor 320 provides the client with an interface for workflow execution, and executes a requested workflow and provides the execution result. Also, the workflow executor 320 gets a latest client's workflow by the customization information version manager 330.

Here, upon receipt of a request for workflow execution from the workflow executor 320, the customization information version manager 330 searches the customized workflow DB 350 to check if the client has a customized workflow.

If it is checked that the client has a customized workflow, the customization information version manager 330 reads out a latest version of workflow information from the customized workflow DB 350. However, if it is checked that the client has no customized workflow, that is, the client uses a basic workflow without any correction thereof, the customization information version manager 330 reads out the basic workflow information from the basic workflow DB 340.

Meanwhile, the apparatus for providing a customized workflow software service in accordance with the embodiment of the present invention can further include a user information DB 360 which stores information being processed during the execution of workflow. The workflow executor 320 executes a workflow using the information which is stored in the user information DB 360.

In a SaaS server, multiple workflow executors 320 may operate in the form of process or thread, each of which can offer service for each different enterprise.

Now, a method for providing a customized workflow software service executed by the apparatus for providing a customized workflow software service in a SaaS environment in accordance with the embodiment of the present invention having the configuration as above will be described in detail.

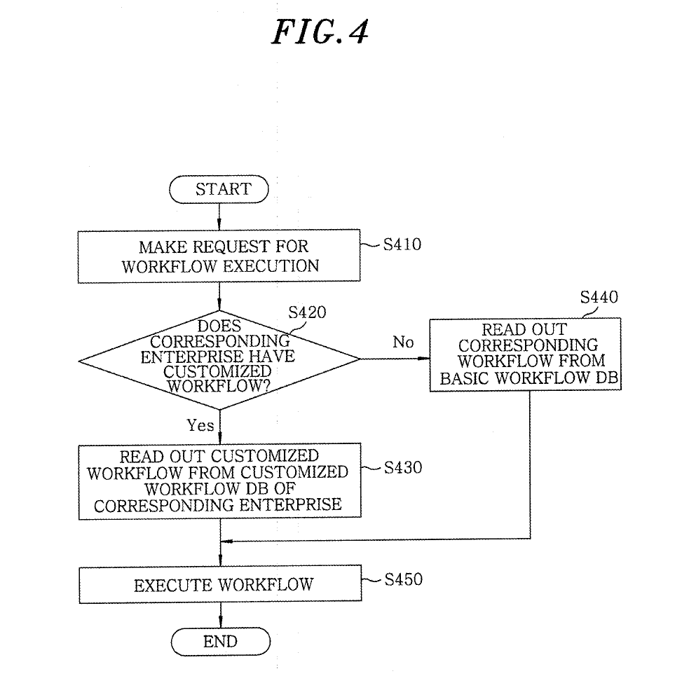

FIG. 4 is a flowchart describing a method for providing a customized workflow software service in a SaaS environment in accordance with the embodiment of the present invention.

Referring to FIG. 4, the client first tries to connect to the apparatus for providing a customized workflow software service through his or her web browser 310. When the connection is made by the client, the workflow executor 320 provides a customized workflow software service client with an interface for workflow execution. At this time, in addition to the provision of the interface, histories with corrected workflow information and version information corresponding to each of the histories may be provided together.

When the client makes a request for workflow execution using the interface in step S910, the process of the present invention searches the customized workflow DB 350 to check if the client has a customized workflow in step S420 in order to obtain a latest version of client's workflow information.

If it is checked that the client has a customized workflow, the process reads out a latest version of workflow information from the customized workflow DB 350 in step S430.

However, if it is checked that the client has no customized workflow, the process reads out basic workflow information from the basic workflow DB 340 in step S440.

Next, the process executes the workflow based on the read workflow information in step S450 and provides the client with the workflow execution result.

As described above, the present invention can provide a customized workflow service in a SaaS form, and thus efficiently offers multiple enterprises with a software service using a small number of servers.

In addition, one SaaS server executes several customized workflow softwares, thereby reducing the number of servers required for providing a software service. This decreases the purchase cost of servers, OSs and softwares, as well as the amount of power consumption and management cost. As a result, the workflow software service can be offered at a low price.

While the invention has been shown and described with respect to the particular embodiments, it will be understood by those skilled in the art that various changes and modification may be made without departing from the scope of the invention as defined in the following claims.

What is claimed is:

1. A method for providing a customized workflow service to offer a customized workflow software service in a software as a service (SaaS) environment, the method comprising:
providing currently set workflow information to a customized workflow software service client;
receiving a request for correction of workflow information from the client; and
storing workflow information corrected in response to the request for correction of workflow information in a customized workflow database.

2. The method of claim 1, wherein if the currently set workflow information is basic workflow information stored in a basic workflow database, said storing workflow information includes copying the basic workflow information into the customized workflow database.

3. The method of claim 1, wherein said storing workflow information includes additionally storing version information corresponding to the corrected workflow information.

4. The method of claim 3, wherein said providing currently set workflow information includes providing histories with corrected workflow information and the version information corresponding to each of the histories.

5. A method for providing a customized workflow software service in a software as a service (SaaS) environment, the method comprising:
receiving a request for workflow execution from a client;
checking a latest version of workflow information of the client;
reading out the latest version of workflow information; and
executing a workflow based on the read latest version of workflow information.

6. The method of claim 5, wherein said checking a latest version of workflow information includes searching a customized workflow database to check if the client has a customized workflow.

7. The method of claim 6, wherein if it is checked that the client has a customized workflow, said reading out the latest version of workflow information, includes reading out the latest version of workflow information from the customized workflow database.

8. The method of claim 6, wherein if it is checked that the client has no customized workflow, said reading out the latest version of workflow information includes reading out basic workflow information from a basic workflow database.

9. The method of claim 5, further comprising, before said executing a workflow:
providing the client with histories with corrected workflow information and workflow version information corresponding to each the histories.

10. The method of claim 5, wherein said executing a workflow includes:
reading out, from a user information database which stores information processed during the execution of the workflow, the information; and
providing the client with the workflow execution result using the information processed during the execution of the workflow.

11. An apparatus for providing a customized workflow service to offer a customized workflow software service in a software as a service (SaaS) environment, the apparatus comprising:
a customization editor for providing a customized workflow software service client with an interface for checking and editing workflow information;
a basic workflow database for storing basic workflow information of the client;
a customized workflow database for storing customized workflow information of the client; and
a customization information version manager for managing workflow information corrected by the client using the customization editor, and storing the corrected workflow information in the customized workflow database.

12. The apparatus of claim 11, wherein if the client firstly corrects the basic workflow information stored in the basic workflow database, the customization information version manager copies the basic workflow information into the customized workflow database.

13. The apparatus of claim 11, wherein the customization information version manager adds version information to the workflow information corrected by the client and stores the added workflow information in the customized workflow database.

14. The apparatus of claim 13, wherein the customization editor provides the client with histories with corrected workflow information and the version information corresponding to each of the histories.

15. An apparatus for providing a customized workflow software service in a software as a service (SaaS) environment, the apparatus comprising:
a workflow executor for providing a customized workflow software service client with an interface for workflow execution, and executing a workflow requested by the client;
a basic workflow database for storing basic workflow information of the client;
a customized workflow database for storing customized workflow information of the client; and
a customization information version manager for selectively reading out a latest version of workflow information from the basic workflow database or the customized workflow database in response to a request for workflow execution received through the workflow executor, and providing the latest version of workflow information to the workflow executor.

16. The apparatus of claim 15, wherein, upon receipt of the request for workflow execution, the customization information version manager searches the customized workflow database to check if the client has a customized workflow.

17. The apparatus of claim 16, wherein if it is checked that the client has a customized workflow, the customization information version manager reads out a latest version of workflow information from the customized workflow database.

18. The apparatus of claim 16, wherein if it is checked that the client has no customized workflow, the customization information version manager reads out the basic workflow information from the basic workflow database.

19. The apparatus of claim 15, wherein the workflow executor provides the client with histories with corrected workflow information and workflow version information corresponding to each of the histories.

20. The apparatus of claim 15, further comprising:
a user information database which stores information processed during the execution of workflow,
wherein the workflow executor executes the workflow using the information and provides the client with the execution result.
